(19) United States
(12) Patent Application Publication
(10) Pub. No.: US 2005/0164719 A1
(43) Pub. Date: Jul. 28, 2005

(54) Mobile telecommunications

(75) Inventor: Desmond Waters, Surrey (GB)

Correspondence Address: YOUNG & THOMPSON, 745 SOUTH 23RD STREET, 2ND FLOOR, ARLINGTON, VA, 22202, US

(73) Assignee: NEC CORPORATION, MINATO-KU (JP)

(21) Appl. No.: 11/032,032

(22) Filed: Jan. 11, 2005

(30) Foreign Application Priority Data
Jan. 12, 2004 (GB) 0400573.2

(51) Int. Cl. H04Q 7/20

(52) U.S. Cl. 455/458

(57) ABSTRACT

This invention relates to mobile telecommunications concerned with 3GPP standard or equivalents, and purpose is improve the specific service (MBMS) in a 3GPP proposal compliant network to minimize impacts on other users. According to a first aspect of this invention, there is provided a method of alerting user equipment to a modification to a system information block in a mobile telecommunication system wherein a generic paging message is provided to signal a modification to the system information block, the method comprising determining whether the modification is specific to a particular service and, if the modification is specific to a particular service, sending a paging message associated with the particular service only to user equipment configured for the service in place of the generic paging message.

The present invention relates to mobile telecommunications and is particularly, but not exclusively, concerned with mobile telecommunications using the third generation partnership project (3GPP) standard or equivalents.

Recently, it has been proposed to provide Multimedia broadcast Multicast Service (MBMS) which will provide additional functionality to users with appropriate equipment. It is a concern to reduce the impact that the provision of this service has on other users, particularly mobile devices which are not configured to receive the Multimedia Broadcast Multicast Service.

Some (or all) of the configuration information for a new service will be available on the System Information Block (SIB) and this information will change if the service is reconfigured. Although the invention is particularly concerned with the case of Multimedia Broadcast Message Service, there may be additional services proposed for which configuration information will be available in the SIB hence similar considerations apply.

In a conventional 3GPP or equivalent system, a change to the system information in the SIB is broadcast to all User Equipment (UE) in the Idle, URA and CELL_PCH states.

Thus, with the existing mechanism, a change in MBMS PICK (or other information in the SIB) will result in all User Equipment (UE) being paged including non-MBMS configured UE.

The invention seeks to alleviate this problem.

According to a first aspect, there is provided a method of alerting user equipment to a modification to a system information block in a mobile telecommunication system wherein a generic paging message is provided to signal a modification to the system information block, the method comprising determining whether the modification is specific to a particular service and, if the modification is specific to a particular service, sending a paging message associated with the particular service only to user equipment configured for the service in place of the generic paging message.

Thus, although the information in the SIB is available to all user equipment and a modification in that information potentially needs to be notified to all equipment, according to the invention it is determined that a particular modification only affects equipment associated with a particular service and the standard notification procedure is bypassed.

According to the preferred implementation, the service is an MBMS service and the particular paging message is an MBMS paging message. This preferably replaces an IE.“BCCH modification information” Paging Type 1 message.

Thus, in a preferred implementation, the invention provides a method of alerting User Equipment configured for MBMS of an update in SIB concerning MBMS configuration information, the method comprising sending an MBMS paging message to the User equipment in place of an IE “BCCH modification information” Paging Type 1 message.

The MBMS configuration information may be MBMS PICH information.

In a closely related second aspect, the invention provides a message for User Equipment configured for an MBMS service comprising information identifying an SIB update.

In a closely related third aspect, the invention provides a method of operating a UTRAN comprising, following an update to SIB information, determining whether the modification is specific to a particular service and, if the modification is specific to a particular service, suppressing a generic paging message alerting User Equipment to a modification. Preferably the generic paging message suppressed is a Paging Type 1 i.e. BCCH modification information message.

The method preferably further comprises sending an alternative paging message to User Equipment associated with the particular service. As in the previous aspects, the particular service is preferably an MBMS service.

According to a fourth aspect, the invention further provides a UTRAN or other network component configured to implement a method according to the first or third aspect.

According to a fifth aspect, the invention further provides a computer program or computer program product comprising instructions for performing any of the method aspects or for providing the message of the second aspect.

According to a sixth aspect, the invention further provides user equipment arranged to respond to a paging message associated with a particular service in place of a generic paging message to respond to an update to system information.

Further aspects and preferred features are set out in the claims or in the following detailed description of a preferred embodiment.

As noted above, although explained in the concept of MBMS for a 3GPP network, the invention is more generally applicable to provision of a service in a mobile network which is available to a sub-set of the mobile population and wherein configuration information for the service is stored in common with other information which may be accessed by mobiles which do not participate in the service.

As will be understood by one skilled in the art, terminology used herein is terminology adopted by the 3GPP working groups and the standards bodies but all terms are intended to encompass equivalents, derivatives or modifications and evolutions of the 3GPP standards or alternative standards.

An embodiment of the invention will now be described, by way of example, with reference to the accompanying drawings in which:

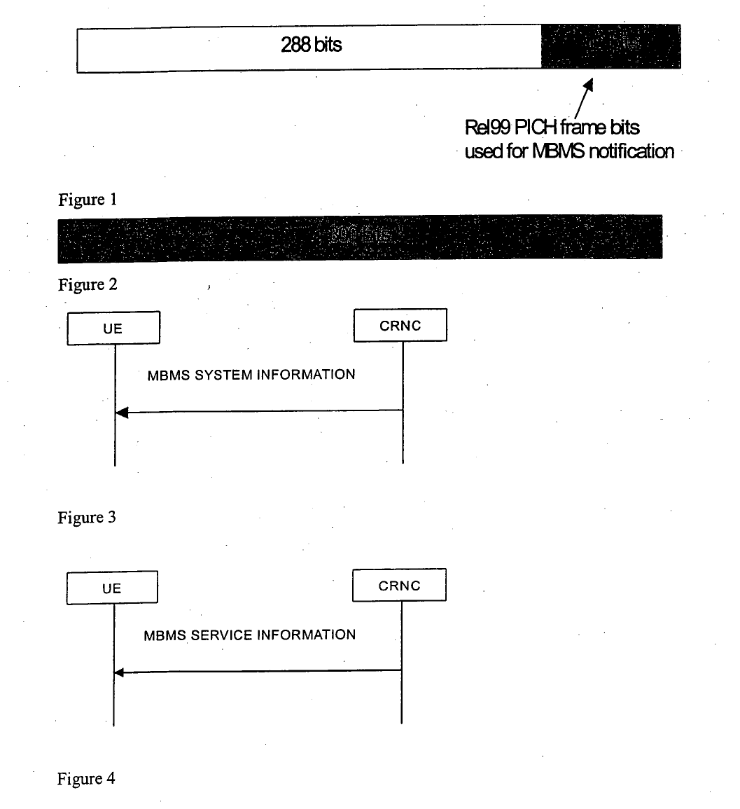

FIG. 1 shows Rel99 PICH frame bits used in MBMS notification;

FIG. 2 shows MBMS Specific PICH frame used in MBMS notification;

FIG. 3 shows Broadcast of MBMS system information in the pre-existing proposal;

FIG. 4 shows MBMS service information signalling flow in the pre-existing proposal;

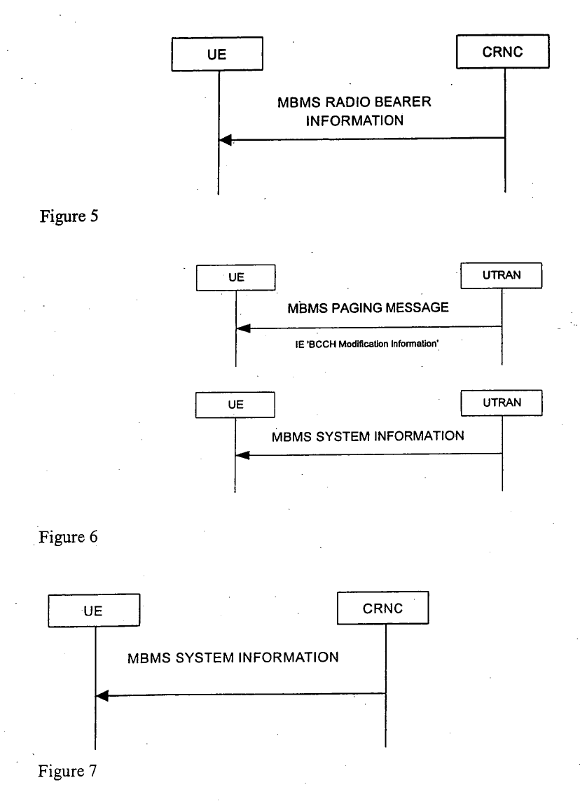

FIG. 5 shows MBMS radio bearer information signalling flow in the pre-existing proposal;

FIG. 6 shows MBMS System Information modification procedure according to an embodiment;

FIG. 7 shows Broadcast of MBMS system information according to an embodiment.

Mobile telecommunications is a field where highly detailed technical specifications and proposals are routinely published extensively to enable mutually interoperable equipment to be developed and one skilled in the art will of course be familiar with the relevant published standards and proposals, which will not be repeated here but are deemed incorporated by reference. In particular, all relevant publications of the 3GPP and ETSI are deemed incorporated herein. Of particular relevance to the present invention is “3GPP TS 25.346 (V2.4.0) Introduction of the Multimedia Broadcast Multicast Service (MBMS) in the Radio Access Network”, the entire content of which is incorporated herein by reference. This document is dynamically updated and references herein are to the version as of Jan. 12, 2004, but changes and modifications are anticipated. Of particular relevance is section 8.2.1. Also of useful background relevance is section 8.1.1.7(RRC standard document 25.331). Extracts of certain sections as of Jan. 12, 2004 are included herein for convenience and the complete documents but of course skilled person will naturally refer to the latest versions which may incorporate modifications. Where extracts are included, this is by way of guidance, for convenience.

Certain acronyms used herein, which will be familiar to one skileed in the art, are summarized for convenience:
MBMS—Multimedia Broadcast/Multicast Service
PICH—Paging Indication Channel
SIB—System Information Block
BCCH—Broadcast Control Channel
PLMN—Public Land Mobile Network
PMM—Packet Mobility Management

By way of background, MBMS Notification as set out in Section 5.1.5 will be explained.

MBMS notification is based on the UE dedicated Rel99 paging occasion. The UE receives the MBMS notification indicators in the last 12 bits of the rel99 PICH frame or in one frame in the MBMS specific PICH. Based on the MBMS notification indicators the UE determines whether it shall receive the rest of the MBMS notification in MCCH or not.

In the present pre-existing proposal, which may be modified in an implementation, under low MBMS load the last 12 bits of the rel99 PICH frame are utilized and in high MBMS load a MBMS specific PICH can be configured in the cell.

UTRAN should repeat the MBMS notification indicators in PICH frames constantly (either the 12 bits or the frame in MBMS specific PICH) at least for the longest DRX cycle used by the MBMS joined UEs in the cell, thus guaranteeing that each MBMS joined UE has received the MBMS notification indicators from PICH at least once.

The physical Channel is explained in Section 6.2.3

SCCPCH is used as a physical channel.

MBMS notification utilizes the 12 available bits of the Rel99 PICH frame in low MBMS load cel as presented in FIG. 1, the exact coding is a matter to be determined for a particular implementation.

MBMS notification utilizes a MBMS specific PICH in high MBMS load cell. MBMS specific PICH frame is present in FIG. 2 the exact coding is to be determined for a particular implementation.

Referring now to Section 8.2 as of Jan. 13, 2004, MBMS Uu Signalling Flows will be explained, Section 8.2.1 explaining the pre-existing proposal for Broadcast of MBMS System Information. FIGS. 3 to 5 depict the signalling Flows.

This signalling flow is applicable for handling MBMS to UEs in PMM IDLE and CONNECTED mode.

The purpose of the signalling flow is for UTRAN to broadcast MBMS system information to UEs using the BCCH. The MBMS SYSTEM INFORMATION shall be repeatedly transmitted after its first transmission. Upon receiving the first MBMS SYSTEM INFORMATION, the UE shall establish the radio bearer carrying an MCCH.

The MBMS SYSTEM INFORMATION includes:
Configuration of a radio bearer carrying an MCCH

More information may be included in the MBMS SYSTEM INFORMATION [FFS].

Section 8.2.2 explains MBMS Service Information

This signalling flow is applicable for handling MBMS to UEs in PMM IDLE and CONNECTED mode.

The purpose of the signalling flow is for RNC to inform UEs of all of MBMS services available in one cell. The MBMS SERVICE INFORMATION message shall be transmitted periodically to support mobility in the MBMS service. The MBMS SERVICE INFORMATION message contains MBMS service ids and ptm indication. The MBMS service ids indicate the MBMS services which are being served in the cell or the MBMS servies which can be served if the UE requests it. Ptm indication indicates that the MBMS service is on ptm in the cell, thus it informs the UE of the need of reception of the MBMS RADIO BEARER INFORMATION message. It is anticipated that more information may be included in the MBMS SERVICE INFORMATION message.

Section 8.2.3 explains MBMS Radio Bearer Information

This signalling flow is pplicable for handling MBMS to UEs in IDLE and PMM CONNECTED mode.

The purpose of the signalling flow is for the RNC to inform UEs regarding the MTCH radio bearer information. MBMS RADIO BEARER INFORMATION is only available for p-t-m transmission. MBMS RADIO BEARER INFORMATION includes MBMS Service Id, MBMS UTRAN Cell Group Identifier, logical channel, transport channel and physical channel information per MBMS service. An MBMS UTRAN Cell Group Identifier is used to indicate to UEs which MBMS Cell Groul the cell pertains to. More information may be included in MBMS RADIO BEARER INFORMATION.

Now with reference to FIGS. 6 to, a modification to the pre-existitng proposal in accordance with the invention will be explained.

In the pre-existing proposal, the IE ‘BCCH Modification Information’ in the RRC Paging Type 1 is used to inform UEs in Idle, URA and CELL_PCH state that SIB information has changed. This requires all UEs in a cell and in some cases the whole PLMN to be paged. Pursuant to the invention we have appreciate that the pre-existing method used to inform UEs of MBMS PICH changes will result in non-MBMS UEs being paged unnecessarily. It is desired to minimise impacts to non-MBMS UEs. The following description, together with FIGS. 6 and 7 shows how this can be achieved by a novel enhancement to the MBMS paging procedure.

By enhancing the MBMS paging message to contain a SIB modification IE similar to the existing SIB modification procedure it is possible to ensure that MBMS UEs are reliably informed of MBMS SIB information changes. However, non-MBMS UEs will be unaffected by the SIB change. We have appreciated that, despite the benefits, the negative network impacts of such a modification would be minimal.

It is the applicants opinion that every effort should be made to ensure the impacts to non-MBMS UEs are kept to an absolute minimum. As explained above, the case of MBMS SIB modification can make use of the MBMS paging procedure with minimal negative impact. It is therefore proposed that this is used to alert UEs to changes in MBMS specific SIB parameters.

The previous section demonstrates the potential to alert MBMS UEs to changes to MBMS specific information on SIB without having any impact to non-MBMS UEs. Having explained the pre-existing proposal, it seems most straightforward to explain the change to the proposal according to the embodiment.

Section 8.2 MBMS Uu signalling Flows and Section 8.2.1 Broadcast of MBMS System Information should be modified based on FIG. 7 showing an alternative broadcast of MBMS system information.

This signalling flow is applicable for handling MBMS to UEs in PMM IDLE and CONNECTED mode.

The purpose of the signalling flow is for UTRAN to broadcast MBMS system information to UEs using the BCCH. The MBMS SYSTEM INFORMATION shall be repeatedly transmitted after its first transmission. Upon receiving the first MBMS SYSTEM INFORMATION, the UE shall establish the radio bearer carrying an MCCH.

The MBMS SYSTEM INFORMATION includes:
Configuration of a radio bearer carrying an MCCH
Configuration of an optional MBMS specific PICH channel

The reconfiguration of MBMS specific information on SIB shall not result in the paging of non-MBMS UEs when non MBMS SIB elements remain unchanged. MBMS UEs shall be notified of the change via MBMS specific signalling.

The above description has concentrated on a particular embodiment in which a specific service (MBMS) in a 3GPP proposal compliant network is improved using the invention to minimize impacts on other users. However, as explained above, the invention is not limited to this specific example (although it offers particular advantages in such a case). In the case of application to other systems, analogous modifications may be made to the corresponding portions of the system, as will be appreciated. Each feature or principle may be applied independently unless otherwise stated.

1. A method of alerting user equipment to a modification to a system information block in a mobile telecommunication system wherein a generic paging message is provided to signal a modification to the system information block, the method comprising determining whether the modification is specific to a particular service and, if the modification is specific to a particular service, sending a paging message associated with the particular service only to user equipment configured of the service in place of the generic paging message.

2. A method according to claim 1 wherein the service is an MBMS service and the paging message associated with the particular service is an MBMS paging message.

3. A method according to claim 2 wherein the generic paging message replaced is an IE “BCCH modification information” Paging Type 1 message.

4. A method of alerting User Euqipment configured for MBMS of an update in SIB concerning MBMS PICH configuration, the method comprising sending an MBMS paging message to the User equipment in place of an IE “BCCH modification information” Paging Type 1 message.

5. A message for User Equipment configured for an MBMS service comprising an MBMS paging message containing information identifying an SIB update.

6. A method of operating a UTRAN comprising: following an update to SIB information, determining whether the modification is specific to a particular service and, if the modification is specific to a particular service, suppressing a generic paging message alerting User Equipment to the modification.

7. A method according to claim 6 wherein the generic paging message suppressed is a Paging Type 1 IE BCCH modification information message.

8. A method according to claim 6 further comprising sending an alternative paging message to User Equipment associated with the particular service.

9. A method according to claim 7 further comprising sending an alternative paging message to User Equipment associated with the particular service.

10. A method according to claim 6, wherein the particular service is preferably an MBMS service.

11. A method according to claim 7, wherein the particular service is preferably an MBMS service.

12. A UTRAN or other network component configured to implement a method according to any of claims 1.

13. A computer program or computer program product comprising instructions for performing any of the methods of claims 1.

14. User equipment arranged to respond to a paging message associated with a particular service in place of a generic paging message to respond to an update to system information.
